(19) United States
(12) Patent Application Publication
(10) Pub. No.: US 2006/0026138 A1
(43) Pub. Date: Feb. 2, 2006

(54) Real-time indexes

(76) Inventors: Gavin Robertson, Arlington, TX (US); Elton Helwig, Dallas, TX (US)

Correspondence Address: HOWISON & ARNOTT, L.L.P, P.O. BOX 741715, DALLAS, TX, 75374-1715, US

(21) Appl. No.: 11/032,496

(22) Filed: Jan. 10, 2005

Related U.S. Application Data
(60) Provisional application No. 60/535,304, filed on Jan. 9, 2004.

(51) Int. Cl. G06F 17/30

(52) U.S. Cl. 707/3

(57) ABSTRACT

A real time index may be formed using a balanced binary tree having nodes and an integer records list associated with the nodes of the balanced binary tree. A query may be conducted on the balanced binary tree to identify a node and the integer records list associated with the node is generated.

### CROSS REFERENCE TO RELATED APPLICATIONS

This application claims benefit of U.S. Provisional Application Ser. No. 60/535,304, filed on Jan. 9, 2004.

### TECHNICAL FIELD OF THE INVENTION

This invention is related to information management systems, particularly indexes for use with data sources.

### BACKGROUND OF THE INVENTION

Indexes for data sources are used to locate data. An index at the back of a book associates terms with pages. Indexes for digital data sources typically associate data with data locations in the same way. Data sources may be configured as a flat-file, hierarchical or network relational database, unstructured text, graphics and other files, semi-structured data and text, as well as other data forms and formats.

Some traditional indexes store a list of integer record numbers for every unique value in a database field. Other indexes use bitmaps to store 0s or 1s for every record in a database, where 1s represent records that contain the unique database field value and 0s represent records that do not. There are advantages and disadvantages of each approach associated with storage, updates and query processing. Integer list indexes tend to be used for live transactional or operational databases requiring constant changes, and therefore constant sorts on integer lists. Bitmap indexes tend to be used for normally static data warehouses and data marts, as bitmaps are normally fixed-length and difficult to allow the insertion or deletion of records. There are other issues associated with the choice of indexes used such as storage and query performance.

Very large databases (VLDBs) have changed traditional approaches to databases, resulting in a clear distinction between live, transactional or operational databases, and normally static data warehouses. These distinctions have resulted in separate vendors for each of these two main approaches. Some vendors have attempted, though few have succeeded, to meet the needs addressed by each approach by providing alternative indexes for each approach. For example, a system may offer both integer list and bitmap indexes. Others have focused on one approach or another, some becoming very specialized, even requiring that proprietary hardware be used, for data warehousing in particular.

Generally, in the computing world, it is easier to batch any operations, allowing for improvements such as sequential processing, cache, and table locking. The disadvantage of batch processing is that it tends to exclude other operations. An example is during batch index update processing, query processing may not be possible. The larger the database and the higher the update rate, the more pronounced this disadvantage is. Most database systems attempt to address this disadvantage by “optimizing” processes. An example is breaking down larger batch updates into smaller batch, incremental updates, which will always be more efficient than processing updates record by record, but less efficient than large batch updates.

Integer lists are like all lists in a live, dynamic situation; they need to be constantly sorted or allowed to remain unsorted for a while, during which performance degrades. For smaller databases, this is not a performance issue, but for larger databases, tending towards VLDBs, list updates could take minutes instead of sub-seconds.

Bitmaps are usually fixed-length and therefore difficult to update as far as inserting or deleting records; changing existing records from 0s to 1s or vice-versa is usually not too difficult.

### SUMMARY OF THE INVENTION

A real time index may be formed using a balanced binary tree having nodes and an integer records list associated with the nodes of the balanced binary tree. A query may be conducted on the balanced binary tree to identify a node and the integer records list associated with the node is generated.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a data organized in a tree-structure;

FIG. 2 illustrates a search tree;

FIG. 3 illustrates a real-time index;

FIG. 4 illustrates a real-time index using multiple balanced binary trees;

FIG. 5 illustrates a real-time index query; and

FIG. 6 illustrates a real-time index using a bitmap.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

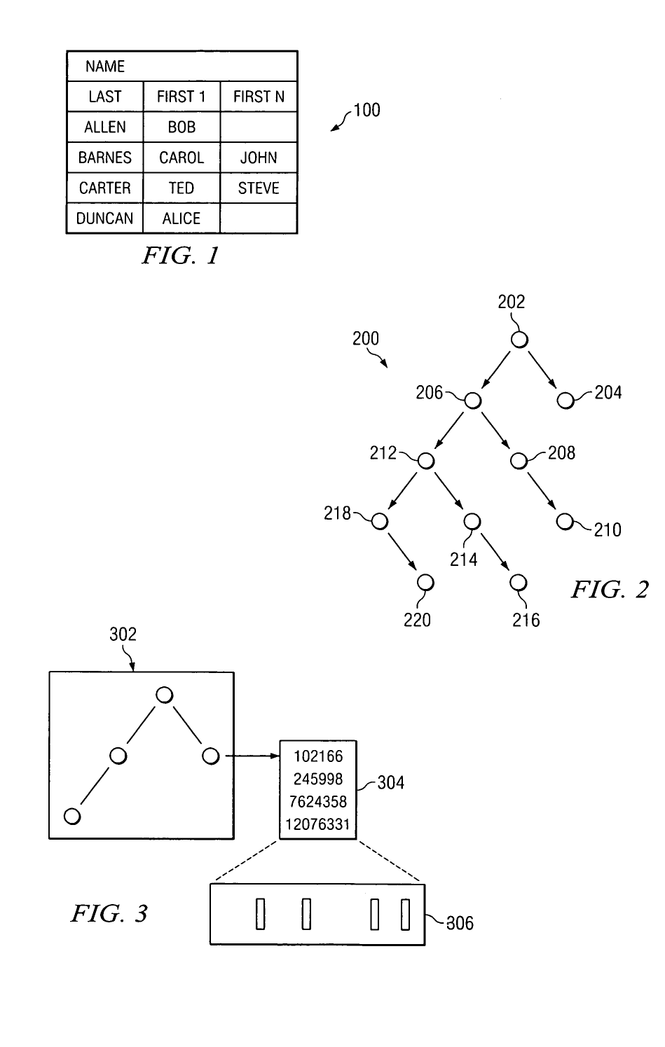

With reference to FIG. 1, a diagram of data organized in a tree structure 100 is shown. A search for an individual by name might involve looking down a list of last names until the last name field matches the last name in the search. When the match is recognized, the search continues down the first name path until the sought first name is found.

With reference to FIG. 2, a diagram of a search tree is shown. At each decision point, 202, 204, 206, 208, 210, 212, a match or no match decision response to the data determines the search path until the search results are identified.

Balanced binary trees are a technology from the 1960s and the attraction then, as it is now, is that binary searches are considered to be the fastest method of searching ordered lists; however, there are a number of problems associated with traditional balanced binary trees, such as scalability, processing speed, and in particular, updateability. As a result, balanced binary trees are usually briefly mentioned and dismissed early on in data and information management literature. However, these problems have been overcome with traditional balanced binary trees.

Levels tend to get very deep, conforming to the n=log₂(x+1) balanced binary tree level rule, where n=number of levels and x=number of nodes, whereby a billion nodes, for instance, need 30 levels; this translates into time to traverse for a query. Rebalancing and rotation after an insert or delete can take considerable time and a very large number of nodes can be affected. A worst-case scenario of deletion of a top node (this problem affects most, if not all, tree structures)

With reference to FIG. 3, a data-flow for a real-time index query 300 is shown. A system implementing real-time indexes can overcome update problems associated with integer lists and bitmaps. The real-time indexes include index trees composed of field data-level nodes. Each field data-level node may point to other index trees consisting of record-level nodes or live updatable bitmaps, depending on the data density. Using real-time indexes allows extremely fast index updates and query availability.

In this configuration, the balanced binary trees do not conform to the n=log₂(x+1) balanced binary tree level rule and as a result relatively few levels are involved in a traverse for a query. Relatively few nodes are involved in a rebalance and rotation after an update, insert or delete, allowing rebalance to occur in microseconds, regardless of database size and data cardinality. In this configuration, deleting the top node is one of the simplest scenarios to deal with; rather than a worst-case.

The power of balanced binary trees comes down to the lack of complex algorithms and therefore overhead, at each node—a binary decision is simple for a computer and therefore software; unlike other tree structures that may have 5 or more branches, from which query decision algorithms have to choose.

A balanced binary tree 302 is subjected to a query, “SELECT x FROM y WHERE Last_Name=“Todd””. The matching node 303, “Todd”, is found and the associated integer list of records 304 is either used directly or converted to a bitmap 306 for subsequent Boolean operations for more complex queries. In this way Boolean operations on integer lists, bitmaps or both in combination can be performed.

Non-real-time indexes may be used for small updates on smaller databases, or any-size updates on normally static larger databases, but are not the best solution for larger updates on live databases; small or large.

The real-time indexes may automatically operate in two modes, either of which is selected at the node-level, rather than the field-level, depending on the data density of specific field values: tree-to-tree mode or tree-to-bitmap mode.

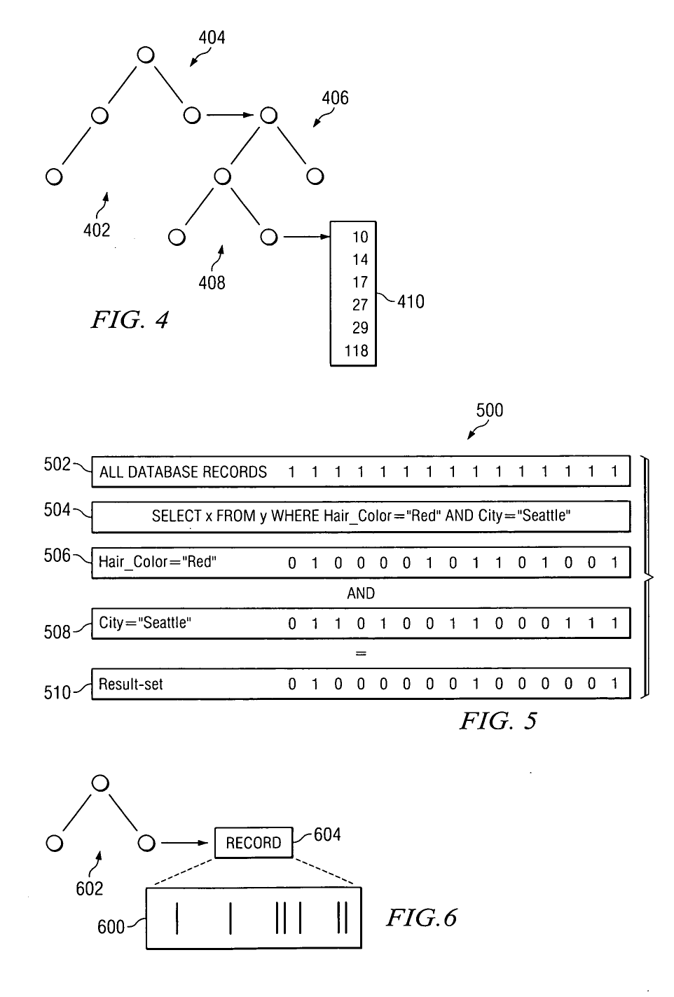

With reference to FIG. 4, a tree-to-tree mode is shown. Instead of attempting to sort a potentially very large list of integers using a modified shell sort or similar, microsecond rebalancing balanced binary trees 402 and 404 are used to maintain a sorted “list” of record integers. The resultant integer list of records 406 obtained from the records tree is used for subsequent query processing, including Boolean operations for more complex queries. As such, Boolean operations on integer lists, bitmaps, or both in combination may be performed.

If the data density for a particular field value (tree node) exceeds a certain percentage of the overall database size (data density), a decision is made for that particular field value (tree node) to use a bitmap instead of a records tree.

With reference to FIG. 5, a query operation process 500 is shown. Bitmaps or integer lists that form the real-time index 502 can be used directly in Boolean operations. For example, by applying query 504 to the real-time index 502, two field values 506 and 508 are ANDed together to generate result 510.

Real-time indexes allow rates from 10s/1000s to 10s of 1000s of records inserted/updated per second on low-level servers. A higher-end example achieved a query and insert rate of 80,000 records per second on a low-level dual processor server.

With reference to FIG. 6, a tree-to-bitmap mode 600 is shown. The search is conducted using balanced binary tree 602 to generate bitmap record 604.

Real-time indexes establish a new method for dealing with large-scale data and information issues, from active (or real-time) data warehousing to near real-time database/index and query performance thought only possible with memory-resident databases. Many applications are tending towards real-time, e.g., interactive customer relationship management (iCRM), inventory management, supply chain management (SCM), and decision support systems (DSS).

One of the major challenges faced by database vendors is enabling simultaneous queries (simple and complex) and data changes (inserts, deletes, and updates) on data and indexes for very large databases (VLDBs) such that data and indexes remain synchronized.

Most database systems are designed for transactions, a large number of users, and simple queries. In such systems, updates are mainly insertions and sequential in nature. Most data warehouses are designed to be normally static, with reduced subsets of data, a small number of users, and complex queries. In these systems, updates are typically performed in regular batches, for instance, overnight.

Real-time indexes, on VLDBs in particular, change the conventional data and information management paradigm, which usually prescribes dividing data and information solutions into real-time live (operational or transactional) or normally static systems, with few, if any, solutions in between. Real-time indexes change that.

One use of of real-time indexes is as part of an EIQ Server product, where real-time indexes are used as default to externally index and query multiple other vendor data sources on multiple platforms in multiple locations. Real-time indexes allow EIQ Server to keep up with any updates to data sources, and at the same time cope with a disproportionately high query load of complex queries on large data sources by a large number of users.

It will be appreciated by those skilled in the art having the benefit of this disclosure that this invention provides a real-time index. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A real time index comprising:
a balanced binary tree having nodes; and
an integer records list associated with the nodes of the balanced binary tree;
wherein a query is conducted on the balanced binary tree to identify a node and the integer records list associated with the node is generated.

2. A real time index comprising:
a first balanced binary tree having nodes; and
a second balanced binary tree associated with one of the nodes of the first balanced binary tree;
wherein a query is conducted on the balanced binary tree to identify a node and the second balanced binary tree associated with the node is generated.

3. A real time index comprising:
a balanced binary tree having nodes; and
a bitmap associated with the nodes of the balanced binary tree;
wherein a query is conducted on the balanced binary tree to identify a node and the bitmap associated with the node is generated.
